(19) United States
(12) Patent Application Publication
(10) Pub. No.: US 2026/0332921 A1
(43) Pub. Date: Oct. 22, 2026

(54) OPTICAL SWITCH FOR NETWORK AND METHOD OF USING

(71) Applicant: Rakuten Symphony, Inc., Tokyo (JP)

(72) Inventors: Vinay VIJ, Tokyo (JP); Parvez KHAN, Boston, MA (US); Lokesh CHIMBILI, Bangalore (IN); Nirav SALOT, Bangalore (IN); Mahesh SIVAPURAM, Bangalore (IN); Prasad HIREMATH, Bangalore (IN); Praveen KONATH, Karnataka (IN)

(21) Appl. No.: 18/840,903

(22) PCT Filed: May 24, 2024
(86) PCT No.: PCT/US2024/030910

§ 371 Date: Aug. 23, 2024

(51) Int. Cl. H04Q 11/00; H04B 10/03

(52) U.S. Cl. CPC H04Q 11/0005; H04B 10/03

(57) ABSTRACT

A system includes an optical switch. The system further includes a first distributed unit (DU) configured to receive first traffic directed from the optical switch along a first optical path, wherein the first DU is configured to generate an alarm condition in response to a failure in a software component of the first DU, and a second DU configured to receive second traffic directed from the optical switch along a second optical path, wherein the optical switch, in response to receiving the alarm condition, is configured to terminate transmission of the first traffic from the optical switch along the first optical path, and transmit the second traffic directed from the optical switch along a second optical path.

### TECHNICAL FIELD

This description relates to an optical switch for a network and a method of using an optical switch.

### BACKGROUND

Open Radio Access Network (O-RAN) technology aims to create more open and interoperable cellular networks. O-RAN is an evolution of Radio Access Network (RAN) architecture. In some instances, O-RAN is controlled by a single operator.

The O-RAN architecture uses a distributed system of intelligent software agents, known as “white boxes,” to control the network. This allows for greater scalability and the ability to use a variety of different hardware components from different vendors.

O-RAN provides the ability to easily add new features and capabilities to the network by use of software-defined networking (SDN) and network functions virtualization (NFV) technologies.

O-RAN also helps to reduce costs for operators by allowing for the use of cheaper and more efficient hardware components. This helps to lower costs, which are potentially a barrier to the deployment of cellular networks.

Some elements of the O-RAN architecture include the Service Management and Orchestration Framework (SMO), RAN Intelligent Controller (RIC), O-Cloud, O-RAN central unit (O-CU or OCU), O-RAN distributed unit (O-DU or ODU), and O-RAN Radio unit (O-RU or ORU).

In some cases, multiple distributed units are present in a single base station and connected to one another by a sequential connection or circuit (“daisy chained”). In such cases, data is transmitted via a single path through all connected units.

A control plane (C-plane) is responsible for signaling and control operations in the network by communicating with other network elements to coordinate and control various functions, such as call setup, mobility management and network resource allocation.

A user plane (U-plane) is responsible for delivering data and voice services to the end-users by transporting the actual user traffic between the radio access network and the core network.

A management plane (M-plane) provides centralized management and monitoring of the network elements, as well as configuration and maintenance of the network. The M-plane is responsible for monitoring the health and performance of the network, collecting statistics, and managing software upgrades and other network changes.

O-RAN provides a more secure network by separating the control plane and the data plane. This allows for greater flexibility in the deployment of security measures, such as firewalls, intrusion detection systems, and encryption.

### SUMMARY

A system includes an optical switch. The system further includes a first distributed unit (DU) configured to receive first traffic directed from the optical switch along a first optical path, wherein the first DU is configured to generate an alarm condition in response to a failure in a software component of the first DU, and a second DU configured to receive second traffic directed from the optical switch along a second optical path, wherein the optical switch, in response to receiving the alarm condition, is configured to terminate transmission of the first traffic from the optical switch along the first optical path, and transmit the second traffic directed from the optical switch along a second optical path.

A method includes transmitting first traffic from an optical switch along a first optical path to a first distributed unit (DU), wherein the first DU is configured to generate an alarm condition in response to a failure in a software component of the first DU, and in response to receiving the alarm condition at the optical switch, terminating transmission of the first traffic from the optical switch along the first optical path, and transmitting second traffic from the optical switch along a second optical path.

A device includes an optical switch configured to transmit first traffic, along a first optical path, to a first distributed unit (DU), wherein the first DU is configured to generate an alarm condition in response to a failure in a software component of the first DU, and the optical switch further configured to, in response to receiving the alarm condition terminate transmission of the first traffic along the first optical path, and transmit second traffic, along a second optical path, to a second distributed unit (DU).

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a network system, in accordance with some embodiments.

FIG. 2 is a diagram of a network system, in accordance with some embodiments.

FIG. 3 is a schematic diagram of a network system, in accordance with some embodiments.

FIG. 4 is a flowchart of a method of using a network system, in accordance with some embodiments.

FIG. 5 is a flowchart of a method of using a network system, in accordance with some embodiments.

FIG. 6 is a block diagram of computer architecture, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Telecommunication networks include optical communications between components within base stations. The optical communication helps to improve speed in transferring signals between components within the base station. In some instances, distributed units (DU) are connected in series, such that an optical signal passes through a first DU prior to continuing to a subsequent DU. In such a situation, if a problem arises in the first DU, a risk that the optical signal will not continue to the subsequent DU is increased. If both the first DU and the subsequent DU are unable to effectively communicate with radio units (RUs), then a risk of failing to provide service to a user increases.

In order to reduce a risk of loss of service to a user, the current description includes an optical switch that is able to control transmission of an optical signal along multiple paths. Each of the paths connects to a single DU, which in turn, is able to control one or more RUs. By using the optical switch, a failure or fault associated with one DU does not impact the ability of the other DUs to communicate with the RUs in order to provide service to the user. In addition to the optical switch, an alarm box is usable to control signals in order to notify DUs regarding whether an optical signal is being sent to the respective DUs.

In some embodiments, a software component failure occurs. In some embodiments, a software component is a DU software component, element, or module. In some embodiments, software switching, updating, or upgrading includes various processes. In some embodiments, a software component failure is an error or failure in one or more processes associated with software switching, updating, or upgrading. For example, a failure occurs when an error during a software upgrade causes a processor to freeze, in some embodiments. In some embodiments, a software component failure occurs when a DU application fails or is not working.

In some situations, a software issue within the first DU limits functionality of the first DU. In some instances, the software issue includes a software update, freezing of software, crashing of software, a software incompatibility, or another suitable software issue. In some embodiments, the software issue prevents the first DU from communicating with related RUs or an optical switch. In some embodiments, the software issue limits the functionality of the first DU by preventing the first DU from performing at least one assigned function. In such a situation, the first DU generates an alarm signal received by the alarm box. The alarm box communicates the alarm signal to the optical switch. In turn, the optical switch transmits a signal through the alarm box to one or more secondary DUs to alert the secondary DUs about an incoming optical signal. The optical switch also transmits an optical signal to the secondary DUs along at least one different optical path. As a result, the secondary DUs are able to communicate with respective RUs and continue to provide service to the user even when communication from the first DU is interrupted.

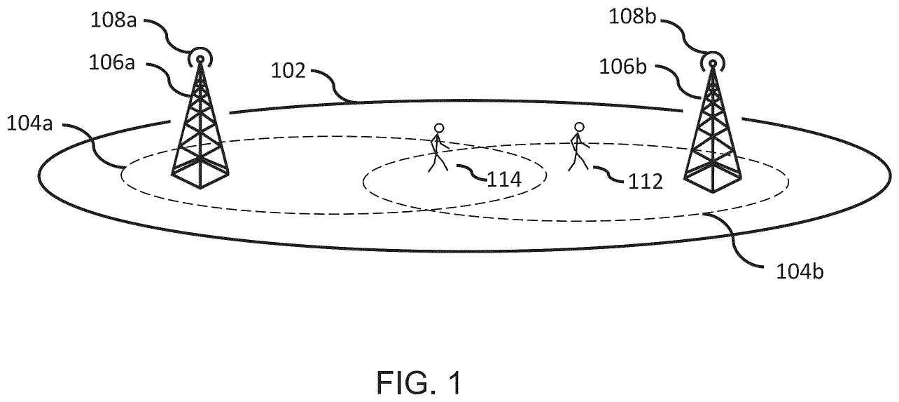

FIG. 1 is a diagram of a network system 100 (hereinafter referred to as “system 100”), in accordance with some embodiments. FIG. 1 is simplified for the purpose of illustration.

System 100 includes a plurality of interconnected devices. In various embodiments, devices correspond to combinations of computing devices, computing systems, servers, server clusters, and/or pluralities of server clusters also referred to as server farms or data centers in some embodiments. The combination of interconnected devices includes processing circuitry configured to be usable to perform some or all of the various operations discussed herein.

In some embodiments, one or more of devices are virtualized network components, e.g., virtualized network functions (VNFs) such as cloud-native network functions (CNFs), including software configured to implement one or more network functions by running on one or more hardware devices. In some embodiments, some or all of devices are configured as some or all of a network function virtualization infrastructure (NFVI). Other configurations and/or types of devices are within the scope of the present disclosure.

In some embodiments, network 102 includes one or more radio access networks (RANs) or a portion of a RAN. In some embodiments, a RAN is a mobile telecommunication system that implements a radio access technology (RAT) and resides between instances of user equipment (UE), e.g., mobile phones, computers, or the like, such as first UE 112 and second UE 114, and provides connection with devices. In some embodiments, a RAN is an open RAN (O-RAN).

In some embodiments, one or more of devices are configured to perform management functions corresponding to network 102. In various embodiments, one or more of devices are configured as one or more of an operations support system (OSS), an element management system (EMS), a network management system (NMS), an access and mobility management function (AMF), or other system or function configured to perform one or more activities supporting operations of network 102.

In some embodiments, one or more of the interconnected devices of network 102 are configured as one or more of a local area network (LAN), a wide area network (WAN), a metropolitan area network (MAN), an internet area network (IAN), a campus area network (CAN), or a virtual private network (VPN). In some embodiments, one or more of the interconnected devices of network 102 are configured as a backbone or core network (CN), a part of a computer network that interconnects networks, providing a path for the exchange of information between different LANs, WANs, etc.

In some embodiments, some of the interconnected devices of network 102 are configured as server clusters, e.g., included in a data center. In some embodiments, the server clusters are part of a cloud computing environment.

In some embodiments, network 104 is some or all of a global system for mobile communications (GSM) RAN, a GSM/EDGE RAN, a universal mobile telecommunications system (UMTS) RAN (UTRAN), an evolved universal terrestrial radio access network (E-UTRAN), open RAN (O-RAN), or cloud-RAN (C-RAN). In some embodiments, network 102 resides between a UE and one or more core networks of system 100.

In some embodiments, network 102 is some or all of a hierarchical telecommunications network, e.g., system 100, including one or more intermediate link(s), also referred to as backhaul portions in some embodiments, between a RAN and one or more core networks. Non-limiting examples of mobile backhaul implementations include fiber-based backhaul, wireless point-to-point backhaul, copper-based wireline, satellite communications, and point-to-multipoint wireless technologies. In some embodiments, backhaul refers to the side of the network that communicates with the global internet.

In the embodiment depicted in FIG. 1, network 102 includes cells 104a and 104b, which include respective base stations 106a and 106b and respective antennas 108a and 108b. In some embodiments, network 102 includes a plurality of cells including cells 104a and 104b and collectively referred to as cells 104 or, in some embodiments, coverage areas 104, a plurality of base stations including base stations 106a and 106b and collectively referred to as base stations 106, and a plurality of antennas including antennas 108a and 108b and collectively referred to as antennas 108.

In the embodiment depicted in FIG. 1, a single base station corresponds to single instances of each of cells 104 and antennas 108. In various embodiments, a single base station corresponds to more than one instance of cells 104 and/or more than one instance of antennas 108.

In some embodiments, base stations 106 are lattice or self-supported towers, guyed towers, monopole towers, and concealed towers (e.g., towers designed to resemble trees, cacti, water towers, signs, light standards, and other types of structures). In some embodiments, a base station is a cellular-enabled mobile device site where antennas and electronic communications equipment are placed, typically on a radio mast, tower, or other raised structure to create a cell (or adjacent cells) in a network. The raised structure typically supports antenna(s) and one or more sets of transmitter/receivers, transceivers, digital signal processors, control electronics, a remote radio head (RRH), primary and backup electrical power sources, and sheltering. Base stations 106 are known by other names such as base transceiver station, mobile phone mast, or cell tower. In some embodiments, base stations 106 are edge devices configured to wirelessly communicate with UEs. The edge device provides an entry point into service provider core networks. Examples include routers, routing switches, integrated access devices (IADs), multiplexers, and a variety of MAN and WAN access devices.

A UE is configured to communicate with base stations 106 via signals transmitted to and from antennas 108.

Network 102 includes a plurality of network nodes, referred to as nodes or RAN nodes in some embodiments. In some embodiments, a node corresponds to one or more devices, a combination of one or more devices and one or more base stations 106, or one or more base stations 106. In some embodiments, a node corresponds to a base station that is an instance of devices.

In some embodiments, a node corresponds to a device configured as a centralized unit (CU) and one or more base stations 106 configured as distributed units (DUs) and/or radio units (RUs). In some embodiments, a node is a next generation RAN (NG-RAN) node, e.g., a gNB an NG-eNB according to 3GPP TS 38.300 specifications.

In some embodiments, some or all of the devices are distributed units. In some embodiments, some or all of the devices are distributed units (DUs). In some embodiments, some or all of the devices are distributed units associated with primary nodes. In some embodiments, some or all of the devices are distributed units associated with secondary nodes. In some embodiments, some or all of the devices are distributed units associated with base stations. In some embodiments, some or all of the devices are distributed units associated with 4G or LTE base stations, or Evolved Node Bases (eNBs). In some embodiments, some or all of the devices are distributed units associated with 5G base stations, or Next Generation Node Bases (gNBs). In some embodiments, some or all of the devices are distributed units associated with primary base stations. In some embodiments, some or all of the devices are distributed units associated with secondary base stations.

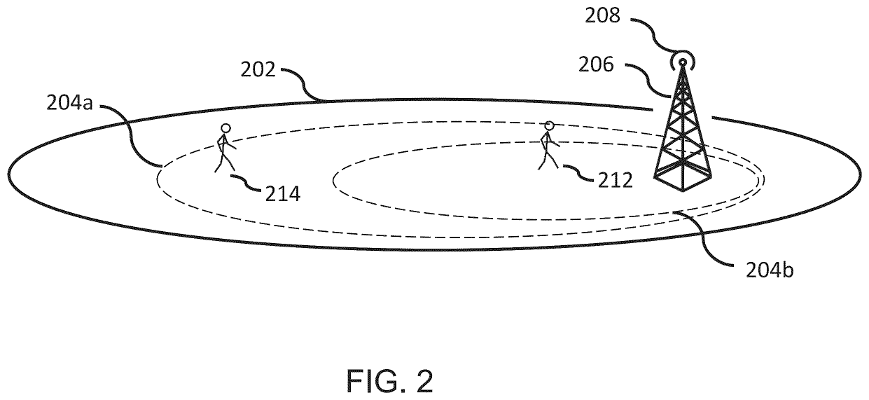

FIG. 2 is a diagram of a network system 200 (hereinafter referred to as “system 200”), in accordance with some embodiments. FIG. 2 is simplified for the purpose of illustration.

System 200 includes a plurality of interconnected, configured as some or all of a network. In various embodiments, devices correspond to combinations of computing devices, computing systems, servers, server clusters, and/or pluralities of server clusters also referred to as server farms or data centers in some embodiments. The combination of interconnected devices includes processing circuitry configured to be usable to perform some or all of the various operations discussed herein.

In some embodiments, one or more of devices are virtualized network components, e.g., virtualized network functions (VNFs) such as cloud-native network functions (CNFs), including software configured to implement one or more network functions by running on one or more hardware devices. In some embodiments, some or all of devices are configured as some or all of a network function virtualization infrastructure (NFVI). Other configurations and/or types of devices are within the scope of the present disclosure.

In some embodiments, network 202 includes one or more radio access networks (RANs) or a portion of a RAN. In some embodiments, a RAN is a mobile telecommunication system that implements a radio access technology (RAT) and resides between instances of user equipment (UE), e.g., mobile phones, computers, or the like, such as first UE 212 and second UE 214, and provides connection with devices such as first device and second device. In some embodiments, a RAN is an open RAN (O-RAN).

In some embodiments, one or more of devices are configured to perform management functions corresponding to network 202. In various embodiments, one or more of devices are configured as one or more of an operations support system (OSS), an element management system (EMS), a network management system (NMS), an access and mobility management function (AMF), or other system or function configured to perform one or more activities supporting operations of network 202.

In some embodiments, one or more of the interconnected devices of network 102 are configured as one or more of a local area network (LAN), a wide area network (WAN), a metropolitan area network (MAN), an internet area network (IAN), a campus area network (CAN), or a virtual private network (VPN). In some embodiments, one or more of the interconnected devices of network 202 are configured as a backbone or core network (CN), a part of a computer network that interconnects networks, providing a path for the exchange of information between different LANs, WANs, etc.

In some embodiments, some of the interconnected devices of network 202 are configured as server clusters, e.g., included in a data center. In some embodiments, the server clusters are part of a cloud computing environment.

In some embodiments, network 104 is some or all of a global system for mobile communications (GSM) RAN, a GSM/EDGE RAN, a universal mobile telecommunications system (UMTS) RAN (UTRAN), an evolved universal terrestrial radio access network (E-UTRAN), open RAN (O-RAN), or cloud-RAN (C-RAN). In some embodiments, network 202 resides between a UE and one or more core networks of system 200.

In some embodiments, network 202 is some or all of a hierarchical telecommunications network, e.g., system 200, including one or more intermediate link(s), also referred to as backhaul portions in some embodiments, between a RAN and one or more core networks. Non-limiting examples of mobile backhaul implementations include fiber-based backhaul, wireless point-to-point backhaul, copper-based wireline, satellite communications, and point-to-multipoint wireless technologies. In some embodiments, backhaul refers to the side of the network that communicates with the global internet.

In the embodiment depicted in FIG. 2, network 202 includes cells 204a and 204b, which include respective base station 206 and respective antenna 208. In some embodiments, network 202 includes a plurality of cells including cells 204a and 204b and collectively referred to as cells 204 or, in some embodiments coverage areas 204, a plurality of base stations including base station 206, and a plurality of antennas including antennas 208.

In the embodiment depicted in FIG. 2, a single base station corresponds to more than one instance of cells 204 and/or more than one instance of a device.

In some embodiments, base stations 206 are lattice or self-supported towers, guyed towers, monopole towers, and concealed towers (e.g., towers designed to resemble trees, cacti, water towers, signs, light standards, and other types of structures). In some embodiments, a base station is a cellular-enabled mobile device site where antennas and electronic communications equipment are placed, typically on a radio mast, tower, or other raised structure to create a cell (or adjacent cells) in a network. The raised structure typically supports antenna(s) and one or more sets of transmitter/receivers, transceivers, digital signal processors, control electronics, a remote radio head (RRH), primary and backup electrical power sources, and sheltering. Base stations 206 are known by other names such as base transceiver station, mobile phone mast, or cell tower. In some embodiments, base stations 206 are edge devices configured to wirelessly communicate with UEs. The edge device provides an entry point into service provider core networks. Examples include routers, routing switches, integrated access devices (IADs), multiplexers, and a variety of MAN and WAN access devices.

In at least one embodiment, an instance of an antenna is a sector antenna, e.g., a directional microwave antenna with a sector-shaped radiation pattern, or a plurality of sector antennae, e.g., configured to have a full-circle coverage area. In some embodiments, an instance of an antenna is a circular antenna. In some embodiments, an instance of an antenna operates at one or more microwave or ultra-high frequency (UHF) frequencies, e.g., ranging from 300 Megahertz (MHz) to 7.2 Gigahertz (GHz). In some embodiments, an instance of an antenna operates at one or more frequencies ranging from 24.2 GHz to 71.0 GHZ.

In various embodiments, a cell is a three-dimensional space having a shape and size based on the configurations of the corresponding base station, e.g., a power level, and antenna, e.g., a number of sectors. In various embodiments, a cell has a substantially spherical, hemispherical, conical, columnar, circular or oval disc, or other shape corresponding to a base station and antenna configuration. In various embodiments, one or both of the shape or size of a cell varies over time, e.g., based on a variable base station power level and/or a variable number of activated antennae and/or antenna sectors. In some embodiments, a cell is referred to as a macro-cell, a micro-cell, a pico-cell, a femto-cell, or a small cell. In some embodiments, a cell is referred to as an indoor small cell (IDSC).

In some embodiments, an instance of UE is a computer or computing system. In some embodiments, an instance of UE has a liquid crystal display (LCD), light-emitting diode (LED) or organic light-emitting diode (OLED) screen interface, such as a graphical user interface providing a touchscreen interface with digital buttons and keyboard or physical buttons along with a physical keyboard. In some embodiments, an instance of UE connects to the internet and interconnects with other devices. In some embodiments, an instance of UE incorporates integrated cameras, the ability to place and receive voice and video telephone calls, video games, and Global Positioning System (GPS) capabilities. In some embodiments, an instance of UE performs as a virtual machine or allows third-party apps to run as a container. In some embodiments, an instance of UE is a computer (such as a tablet computer, netbook, digital media player, digital assistant, graphing calculator, handheld game console, handheld personal computer (PC), laptop, mobile internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card.

A UE is configured to communicate with base stations 206 via signals transmitted to and from antennas 208.

Network 202 includes a plurality of network nodes, referred to as nodes or RAN nodes in some embodiments. In some embodiments, a node corresponds to one or more devices, a combination of one or more devices and one or more base stations 206, or one or more base stations 206. In some embodiments, a node corresponds to a base station that is an instance of devices.

In some embodiments, a node corresponds to a device configured as a centralized unit (CU) and one or more base stations 206 configured as distributed units (DUs) and/or radio units (RUs). In some embodiments, a node is a next generation RAN (NG-RAN) node, e.g., a gNB an NG-eNB according to 3GPP TS 38.300 specifications.

In some embodiments, some or all of the devices are distributed units. In some embodiments, some or all of the devices are distributed units (DUs). In some embodiments, some or all of the devices are distributed units associated with primary nodes. In some embodiments, some or all of the devices are distributed units associated with secondary nodes. In some embodiments, some or all of the devices are distributed units associated with base stations. In some embodiments, some or all of the devices are distributed units associated with 4G or LTE base stations, or Evolved Node Bases (eNBs). In some embodiments, some or all of the devices are distributed units associated with 5G base stations, or Next Generation Node Bases (gNBs). In some embodiments, some or all of the devices are distributed units associated with primary base stations. In some embodiments, some or all of the devices are distributed units associated with secondary base stations. In some embodiments, a base station includes a distributed unit associated with one or more radio units. In some embodiments, a base station includes multiple distributed units, each associated with one or more radio units.

Nodes are interconnected to each other and to network management entities, e.g., an EMS or AMF, through various interfaces. In some embodiments, interfaces between nodes and core network elements are referred to as NG interfaces. In some embodiments, interfaces between various nodes, e.g., NG-RAN nodes, are referred to as Xn interfaces.

The systems and methods herein are usable to help ensure that network resources in network 202 are more efficiently utilized. By utilizing a failover process, the systems and methods herein help to ensure that network component failures are less often catastrophic. For example, in some instances, a disruption or failure associated with a first DU or RU associated with services associated with cell 204a are prevented from impacting services associated with cell 204b, and vice versa.

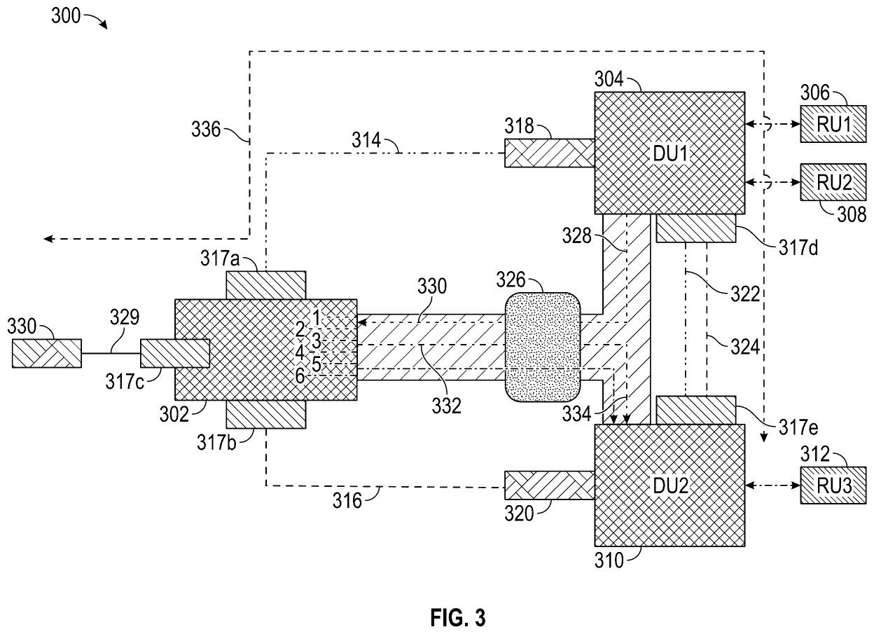

FIG. 3 is a schematic diagram of a network system 300, in accordance with some embodiments. The network system 300 is capable of executing, or carrying out, one or more failover or protection processes in response to an alarm or alarm condition.

The network system 300 includes an optical switch 302. In some embodiments, a switch is an electronic switch. In some embodiments, a switch is an optical switch. In some embodiments, an optical switch is a device used to open or close an optical circuit. In some embodiments, an optical switch is a mechanical switch. In some embodiments, an optical switch is an optomechanical switch. In some embodiments, a switch is a hybrid of both an electronic and an optical switch. Herein, an “optical switch” refers to a switch that is an optical switch or a switch that is a hybrid of both an electronic and an optical switch or any other combination of the aforementioned. In some embodiments, an optical switch is a fiberoptic switch. In some embodiments, an optical switch is a programmable switch. In some embodiments, an optical switch is a 1×N programmable switch connecting a fiberoptic input channel to any of N output channels. In some embodiments, an optical switch is an N×N programmable switch connecting any of N fiberoptic input channels to any of N output channels. In some embodiments, an optical switch is single-mode. In some embodiments, an optical switch is multimode. In some embodiments, an optical switch is bidirectional. In some embodiments, an optical switch uses space division switching. In some embodiments, an optical switch uses wavelength division switching. In some embodiments, an optical switch uses time division switching. In some embodiments, an optical switch uses a hybrid or combination of the aforementioned switching.

In some embodiments, an optical switch automatically connects a first optical path or fiber to a second optical path or fiber. In some embodiments, an optical switch transmits signal in an optical domain or maintains a signal in an optical domain. In some embodiments, an optical switch is an optical transistor. In some embodiments, an optical switch is a light valve. In some embodiments, an optical switch amplifies an optical signal. In some embodiments, an optical switch selectively changes signals between optical fibers or integrated optical circuits.

In some embodiments, an optical switch is a protective switch capable of protection switching to complete or break an optical path. In some embodiments, an optical switch has a switching time in the 1-10 ms range. In some embodiments, an optical switch has a switching time less than 1 ms. In some embodiments, an optical switch has a switching time less than 10 ms. In some embodiments, an optical switch has a switching time less than 100 ms. In some embodiments, an optical switch has a switching time greater than 100 ms. In some embodiments, an optical switch is capable of reversion.

In some embodiments, an optical switch redirects an optical signal from a first path to a second path. In some embodiments, an optical switch uses a stepper motor to redirect an optical path. In some embodiments, a stepper motor moves a mirror, prisms, or directional couplers to direct light from an input to a desired output.

The optical switch 302 is configured to communicate with a first distributed unit (“DU1”) 304. The first distributed unit 304 is configured to communicate with a first radio unit (“RU1”) 306 and a second radio unit (“RU2”) 308.

In some embodiments, the first distributed unit 304 is an O-RAN DU (O-DU). In some embodiments, an O-DU is a commercial off-the-shelf (COTS) edge server.

The optical switch 302 is configured to communicate with a second distributed unit (“DU2”) 310. The second distributed unit 310 is configured to communicate with a third radio unit (“RU3”) 312.

In some embodiments, any or all of the first radio unit 306, the second radio unit 308, or the third radio unit 312 are transceivers on wireless base stations. In some embodiments, any or all of the first radio unit 306, the second radio unit 308, or the third radio unit 312 are configured to transmit or receive data for a same network provider. In some embodiments, at least one of the first radio unit 306, the second radio unit 308 or the third radio unit 312 is configured to transmit or receive data for a different network provider from one of the other first radio unit 306, the second radio unit 308 or the third radio unit 312. In some embodiments, any or all of the first radio unit 306, the second radio unit 308, or the third radio unit 312 are configured to transmit or receive a signal using a same technology, such as fifth generation (5G), fourth generation (4G), long term evolution (LTE) or another suitable technology. In some embodiments, at least one of the first radio unit 306, the second radio unit 308 or the third radio unit 312 is configured to transmit or receive data using a different technology from one of the other first radio unit 306, the second radio unit 308 or the third radio unit 312.

In some embodiments, any or all of the first radio unit 306, the second radio unit 308, or the third radio unit 312 are installed on a first base station. In some embodiments, any or all of the first radio unit 306, the second radio unit 308, or the third radio unit 312 are installed on a second base station. In some embodiments, any or all of the first radio unit 306, the second radio unit 308, or the third radio unit 312 are installed on the same base station. In some embodiments, any or all of the first radio unit 306, the second radio unit 308, or the third radio unit 312 are installed on different base stations.

In some embodiments, any or all of the first radio unit 306, the second radio unit 308, or the third radio unit 312 are usable with a 4G network or 4G capable devices. In some embodiments, any or all of the first radio unit 306, the second radio unit 308, or the third radio unit 312 are usable with an LTE network or LTE capable devices. In some embodiments, any or all of the first radio unit 306, the second radio unit 308, or the third radio unit 312 are usable with a 5G network or 5G capable devices.

In some embodiments, any or all of the first radio unit 306, the second radio unit 308, or the third radio unit 312 are comprised of identical hardware. In some embodiments, any or all of the first radio unit 306, the second radio unit 308, or the third radio unit 312 are comprised of different hardware.

In some embodiments, the second distributed unit 310 is an O-RAN DU (O-DU). In some embodiments, an O-DU is a commercial off-the-shelf (COTS) edge server.

The optical switch 302 is configured to communicate with the first distributed unit 304 via a first connection 314. In some embodiments, the first connection 314 is a fiber optic line. In some embodiments, the first connection 314 is a fiber optic cable.

The optical switch 302 is configured to communicate with the second distributed unit 310 via a second connection 316. In some embodiments, the second connection 316 is a fiber optic line. In some embodiments, the second connection 316 is a fiber optic cable.

The first connection 314 interfaces with the first distributed unit 304 via module 318. In some embodiments, the module 318 is a small form-factor fiber optic connector. In some embodiments, the module 318 is an optical transceiver module. In some embodiments, the module 318 is a small form-factor pluggable (SFP). In some embodiments, the module 318 is an optical port. In some embodiments, an SFP is suitable for use with 25G Ethernet.

The second connection 316 interfaces with the second distributed unit 310 via module 320. In some embodiments, the module 320 is a small form-factor fiber optic connector. In some embodiments, the module 320 is an optical transceiver module. In some embodiments, the module 320 is a small form-factor pluggable (SFP). In some embodiments, the module 320 is an optical port. In some embodiments, an SFP is suitable for use with 25G Ethernet.

The first connection 314 interfaces with the optical switch 302 via module 317a. In some embodiments, the module 317a is a small form-factor fiber optic connector. In some embodiments, the module 317a is an optical transceiver module. In some embodiments, the module 317a is a small form-factor pluggable (SFP). In some embodiments, the module 317a is an optical port. In some embodiments, an SFP is suitable for use with 25G Ethernet.

The second connection 316 interfaces with the optical switch 302 via module 317b. In some embodiments, the module 317b is a small form-factor fiber optic connector. In some embodiments, the module 317b is an optical transceiver module. In some embodiments, the module 317b is a small form-factor pluggable (SFP). In some embodiments, the module 317b is an optical port. In some embodiments, an SFP is suitable for use with 25G Ethernet.

The first distributed unit 304 is configured to communicate with the second distributed unit 310 via third connection 322. In some embodiments, the third connection 322 is a fiber optic line. In some embodiments, the third connection 322 is a fiber optic cable.

The third connection 322 interfaces with the first distributed unit 304 via module 317d. The third connection 322 interfaces with the second distributed unit 310 via module 317e. In some embodiments, one or both of modules 317d or module 317e is a small form-factor fiber optic connector. In some embodiments, one or both of module 317d or module 317e is an optical transceiver module. In some embodiments, one or both of module 317d or module 317e is a small form-factor pluggable (SFP). In some embodiments, one or both of module 317d or module 317e is an optical port. In some embodiments, an SFP is suitable for use with 25G Ethernet.

The second distributed unit 310 is configured to communicate with the first distributed unit 304 via fourth connection 324. In some embodiments, the fourth connection 324 is a fiber optic line. In some embodiments, the fourth connection 324 is a fiber optic cable.

The fourth connection 324 interfaces with the first distributed unit 304 via module 317d. The fourth connection 324 interfaces with the second distributed unit 310 via module 317e. In some embodiments, one or both of module 317d or module 317e is a small form-factor fiber optic connector. In some embodiments, one or both of module 317d or module 317e is an optical transceiver module. In some embodiments, one or both of module 317d or module 317e is a small form-factor pluggable (SFP). In some embodiments, one or both of module 317d or module 317e is an optical port. In some embodiments, an SFP is suitable for use with 25G Ethernet.

The first distributed unit 304 is configured to communicate with, or deliver signals to, alarm module 326 via fifth connection 328. In some embodiments, the fifth connection 328 is a fiber optic line. In some embodiments, the fifth connection 328 is a fiber optic cable. In some embodiments, the fifth connection 328 is an electrical line. In some embodiments, the fifth connection 328 is an electrical cable. In some embodiments, the fifth connection 328 is an electrical connection.

The alarm module 326 is configured to communicate with, or deliver signals to, optical switch 302 via sixth connection 330. In some embodiments, the sixth connection 330 is a fiber optic line. In some embodiments, the sixth connection 330 is a fiber optic cable. In some embodiments, the sixth connection 330 is an electrical line. In some embodiments, the sixth connection 330 is an electrical cable. In some embodiments, the sixth connection 330 is an electrical connection.

The optical switch 302 is configured to communicate with, or deliver signals generated to, alarm module 326 via seventh connection 332. For example, in some embodiments, the optical switch 302 is configured to generate or transmit a notification signal to alarm module 326 in response to receiving an alarm condition or signal from alarm module 326. In some embodiments, the seventh connection 332 is a fiber optic line. In some embodiments, the seventh connection 332 is a fiber optic cable. In some embodiments, the seventh connection 332 is an electrical line. In some embodiments, the seventh connection 332 is an electrical cable. In some embodiments, the seventh connection 332 is an electrical connection.

The alarm module 326 is configured to communicate with, or deliver signals to, the second distributed unit 310 via eighth connection 334. In some embodiments, the eighth connection 334 is a fiber optic line. In some embodiments, the eighth connection 334 is a fiber optic cable. In some embodiments, the eighth connection 334 is an electrical line. In some embodiments, the eighth connection 334 is an electrical cable. In some embodiments, eighth connection 334 is an electrical connection.

In some embodiments, alarm module 326 is a dry contact, volt free contact, or potential free contact alarm. In some embodiments, alarm module 326 is a wet contact alarm. In some embodiments, alarm module 326 is part of a relay circuit. In some embodiments, alarm module 326 is a single-pole switch. In some embodiments, alarm module 326 comprises multiple alarm circuits or switches.

The optical switch 302 is configured to communicate with, handle, route, direct, or redirect incoming data from an incoming connection 329. In some embodiments, data includes incoming traffic or packets from a data center or other source. In some embodiments, the incoming connection 329 is a fiber optic line. In some embodiments, the incoming connection 329 is a fiber optic cable. The incoming connection 329 interfaces with the optical switch 302 via module 317c. The incoming connection 329 interfaces with the source via module 330. In some embodiments, one or both of module 317c or module 330 is a small form-factor fiber optic connector. In some embodiments, one or both of module 317c or module 330is an optical transceiver module. In some embodiments, one or both of module 317c or module 330is a small form-factor pluggable (SFP). In some embodiments, one or both of module 317c or module 330 is an optical port. In some embodiments, an SFP is suitable for use with 25G Ethernet. In some embodiments, optical switch 302 routes or directs traffic along a primary path 336. In some embodiments, optical switch 302 re-routes or re-directs traffic away from a primary path 336.

In some embodiments, a primary path includes directing traffic to, or through, first connection 314. In some embodiments, a primary path includes directing traffic to, or through, first distributed unit 304. In some embodiments, a primary path includes directing traffic to, or through, third connection 322. In some embodiments, a primary path includes directing traffic to, or through, second distributed unit 310.

In some embodiments, a primary path includes directing traffic to, or through, first connection 314, followed by directing traffic to, or through, first distributed unit 304. In some embodiments, a primary path includes directing traffic to, or through, first distributed unit 304, followed by directing traffic to, or through third connection 322. In some embodiments, a primary path includes directing traffic to, or through, third connection 322, followed by directing traffic to, or through, second distributed unit 310. In some embodiments, a primary path includes directing traffic to, or through, first connection 314, followed by directing traffic to, or through, first distributed unit 304, and further followed by directing traffic to, or through, third connection 322, and further followed by directing traffic to, or through, second distributed unit 310.

In some embodiments, optical switch 302 routes or directs traffic along a secondary path.

In some embodiments, a secondary path includes directing traffic to, or through, second connection 316. In some embodiments, a secondary path includes directing traffic to, or through, second distributed unit 310. In some embodiments, a secondary path includes directing traffic to, or through, fourth connection 324. In some embodiments, a secondary path includes directing traffic to, or through, first distributed unit 304.

In some embodiments, a secondary path includes directing traffic to, or through, second connection 316, followed by directing traffic to, or through, second distributed unit 310. In some embodiments, a secondary path includes directing traffic to, or through, second distributed unit 310, followed by directing traffic to, or through fourth connection 324. In some embodiments, a secondary path includes directing traffic to, or through, fourth connection 324, followed by directing traffic to, or through, first distributed unit 304. In some embodiments, a secondary path includes directing traffic to, or through, second connection 316, followed by directing traffic to, or through, second distributed unit 310, and further followed by directing traffic to, or through, fourth connection 324, and further followed by directing traffic to, or through, first distributed unit 304.

In some embodiments, a secondary path is inactive when a primary path is active.

The network system 300 is capable of executing, or carrying out, one or more failover processes. In some embodiments, a failover process includes re-routing traffic from a first path to a second path to mitigate the impact of an optical fault.

In some embodiments, a software component failure occurs. In some embodiments, a software component is a first DU 304 software component, element, or module. In some embodiments, software switching, updating, or upgrading includes various processes. In some embodiments, a software component failure is an error or failure in one or more processes associated with software switching, updating, or upgrading. For example, a failure occurs when an error during a software upgrade causes a processor to freeze, in some embodiments. In some embodiments, a software component failure occurs when a first DU 304 application fails or is not working.

In some situations, a software issue within the first DU 304 limits functionality of the first DU 304. In some instances, the software issue includes a software update, freezing of software, crashing of software, a software incompatibility, or another suitable software issue. In some embodiments, the software issue prevents the first DU 304 from communicating with related RUs or the optical switch 302. In some embodiments, the software issue limits the functionality of the first DU 304 by preventing the first DU 304 from performing at least one assigned function. The failover or protections systems and methods described herein mitigate the impact of such a software issue on second DU 310 by re-routing traffic around first DU 304 or excluding first DU 304 from the traffic path or circuit.

In some embodiments, an optical fault is detected by a loss of signal, communication, current, or connection from first DU 304 at alarm module 326. In some embodiments, an optical fault is detected by a loss of current in a circuit including first DU 304. In some embodiments, an optical fault is detected by a loss of current from fifth connection 328 at alarm module 326.

In some embodiments, alarms, signals, or alarm signals are generated or propagated from alarm module 326 to or from optical switch 302, to or from first DU 304, and to or from second DU 310. In some embodiments, alarms, signals, or alarm signals are generated or propagated from first DU 304, and to or from alarm module 326. In some embodiments, alarms, signals, or alarm signals are generated or propagated as changes in current or connections in particular circuits including particular elements. For example, an alarm may be generated by propagating an electrical current, or loss of an electrical current, to optical switch 302 on a particular pin or set of pins. In some embodiments, a particular pin or set of pins are associated with particular elements. For example, in some embodiments, a first and second pin on optical switch 302 are associated with first DU 304. In some embodiments, a loss of current is propagated from alarm module 326 to a first and second pin, indicating an alarm associated with first DU 304.

In some embodiments, unique alarm codes are generated, communicated, delivered, or propagated from alarm module 326 to or from optical switch 302, to or from first DU 304, and to or from second DU 310. In some embodiments, unique alarm codes are generated, communicated, delivered, or propagated from first DU 304 to or from optical switch 302, to or from alarm module 326, and to or from second DU 310. In some embodiments, unique alarm codes are generated, communicated, delivered, or propagated from second DU 310 to or from optical switch 302, to or from alarm module 326, and to or from first DU 304. In some embodiments, unique alarm codes are generated, communicated, delivered, or propagated to an operating support system (OSS) from second DU 310, optical switch 302, alarm module 326 or first DU 304. In some embodiments, a unique alarm code includes a code corresponding to, or indicating, a software component failure. In some embodiments, a unique alarm code includes a code corresponding to, or indicating, a software component failure in first DU 304.

In some embodiments, an optical fault is detected by alarm module 326, according to methods herein. In some examples, the method 400 is usable to detect an optical fault. In some examples, the method 500 is usable to detect an optical fault. In some embodiments, methods other than method 400 or method 500 are usable to detect an optical fault.

In some embodiments, a determination is made whether the alarm or alarm condition associated with first DU 304 is cured or resolved at an alarm module 326. In some embodiments, an indication that an alarm or alarm condition is cured or resolved is received at a dry contact alarm or alarm box. In some embodiments, if a determination is made that an alarm or alarm condition associated with first DU 304 is cured or resolved, delivery of packets, data, or traffic to second DU 310 are discontinued or terminated. In some embodiments, optical switch 302 discontinues or terminates delivery of packets, data, or traffic on a fiber optic line or cable associated with second DU 310.

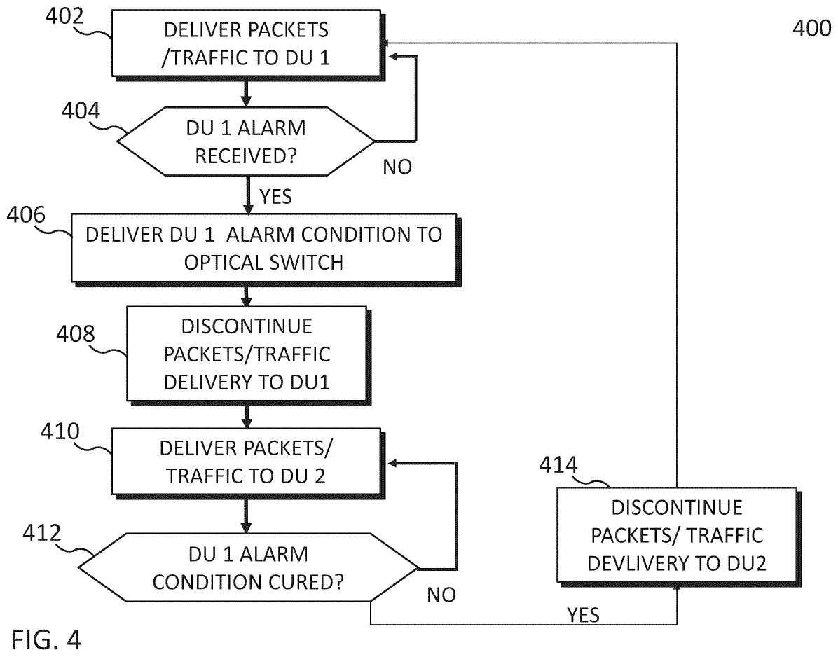

FIG. 4 is a flowchart of a method of using a network system, in accordance with some embodiments. The method 400 is usable by an O-RAN system in order to help ensure that network resources are more efficiently utilized. By utilizing a failover process, the method 400 helps to ensure that network component failures are less often catastrophic. In some embodiments, the method 400 is able to be executed by the O-RAN system 100 (FIG. 1) or the O-RAN system 200 (FIG. 2). In some embodiments, the method 400 is able to be executed by an O-RAN system other than the O-RAN system 100 (FIG. 1) or the O-RAN system 200 (FIG. 2). In some embodiments, the method 400 is usable with network system 300 (FIG. 3). In some embodiments, the method 400 is usable with a system other than network system 300 (FIG. 3).

In operation 402, packets, data, or traffic are delivered to a first DU (“DU 1”). In some embodiments, DU 1 is an O-DU. In some embodiments, packets, data, or traffic are routed or delivered via one or more fiber optic cables or lines. In some embodiments, packets, data, or traffic are routed or delivered through or using a switch. In some embodiments, a switch is an optical switch, according to embodiments herein. In some embodiments, a fiber optic cable or line is connected to DU 1 using a small form-factor fiber optic connector.

In operation 404, a determination is made whether an alarm associated with DU 1 is received at an alarm module. In some embodiments, the alarm associated with DU 1 is due to a software component failure. In some embodiments, a software component is a DU 1 software component, element, or module. In some embodiments, software switching, updating, or upgrading includes various processes. In some embodiments, a software component failure is an error or failure in one or more processes associated with software switching, updating, or upgrading. For example, a failure occurs when an error during a software upgrade causes a processor to freeze, in some embodiments. In some embodiments, a software component failure occurs when a DU 1 application fails or is not working. In some embodiments, the alarm associated with DU 1 is due to a software issue in DU 1. In some instances, the software issue includes a software update, freezing of software, crashing of software, a software incompatibility, or another suitable software issue. In some embodiments, the software issue prevents the first DU from communicating with related RUs or an optical switch. In some embodiments, the software issue limits the functionality of the first DU by preventing the first DU from performing at least one assigned function. In some embodiments, an alarm is received at a dry contact alarm or alarm box. In some embodiments, if a determination is made that an alarm associated with DU 1 is not received, operation 402 is executed or continues to be executed. In some embodiments, if a determination is made that an alarm associated with DU 1 is not received, operation 406 is executed.

In operation 406, an alarm condition associated with DU 1 is delivered, triggered, or communicated to an optical switch, according to embodiments herein. In some embodiments, an alarm condition associated with DU 1 is delivered, triggered, or communicated when optical power degradation, line or equipment faults are detected by the optical switch. In some embodiments, optical power degradation, line or equipment faults are detected when optical power in a line or circuit associated with DU 1 crosses beyond a threshold. In some embodiments, optical power degradation, line or equipment faults are detected when optical power in a line or circuit associated with DU 1 falls below a threshold. In some embodiments, a threshold is configured by a user at, on, or using the optical switch.

In operation 408, delivery of packets, data, or traffic to a first DU (“DU 1”) are discontinued or terminated. In some embodiments, an optical switch discontinues delivery of packets, data, or traffic on a fiber optic line or cable associated with DU 1.

In operation 410, packets, data, or traffic are delivered to a second DU (“DU 2”). In some embodiments, DU 2 is an O-DU. In some embodiments, packets, data, or traffic are routed or delivered via one or more fiber optic cables or lines. In some embodiments, packets, data, or traffic are routed or delivered through or using a switch. In some embodiments, a switch is an optical switch, according to embodiments herein. In some embodiments, a fiber optic cable or line is connected to DU 2 using a small form-factor fiber optic connector.

In operation 412, a determination is made whether the alarm or alarm condition associated with DU 1 is cured or resolved at an alarm module. In some embodiments, an indication that an alarm or alarm condition is cured or resolved is received at a dry contact alarm or alarm box. In some embodiments, if a determination is made that an alarm or alarm condition associated with DU 1 is cured or resolved, operation 414 is executed. In some embodiments, if a determination is made that an alarm or alarm condition associated with DU 1 is not cured or resolved, operation 410 is executed, or continues to be executed.

In operation 414, delivery of packets, data, or traffic to the second DU (“DU 2”) are discontinued or terminated. In some embodiments, an optical switch discontinues or terminates delivery of packets, data, or traffic on a fiber optic line or cable associated with DU 2. One of ordinary skill in the art would understand that additional operations are possible within method 400 in some embodiments. For example, in some embodiments, the method 400 further includes providing or propagating additional alarms or signals to other components. In some embodiments, an order of operations of the method 400 is changed. For example, in some embodiments the operation 410 is performed prior to the operation 408. In some embodiments, at least one operation of the method 400 is omitted. For example, in some embodiments, the operation 404 is omitted.

Utilizing the method 400 helps to efficiently utilize network resources. For example, in some situations, a fault or failure in a first DU is not propagated to an otherwise functional second DU by providing additional circuits or pathways to circumvent a faulty circuit or pathway. Similarly, in some situations, an optical switch allows protective switching to preserve otherwise functional components during a fault condition. As a result, the network is more likely to function as intended following network faults the network in comparison with other approaches that fail to provide failover methods.

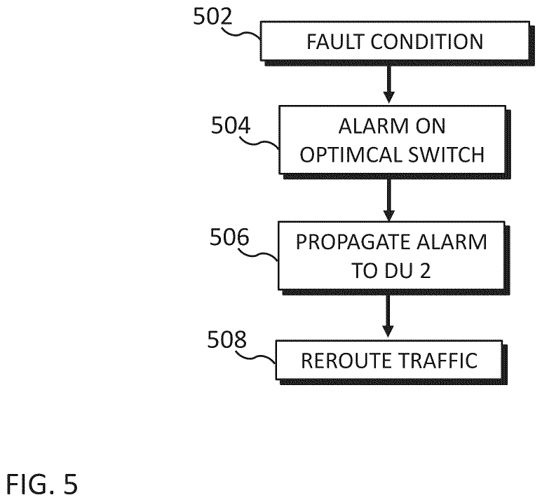

FIG. 5 is a flowchart of a method of using a network system, in accordance with some embodiments. The method 500 is usable by an O-RAN system in order to help ensure that network resources are more efficiently utilized. By utilizing a failover process, the method 500 helps to ensure that network component failures are less often catastrophic. In some embodiments, the method 400 is able to be executed by the O-RAN system 100 (FIG. 1) or the O-RAN system 200 (FIG. 2). In some embodiments, the method 500 is able to be executed by an O-RAN system other than the O-RAN system 100 (FIG. 1) or the O-RAN system 200 (FIG. 2).

In operation 502, a fault condition is triggered, delivered, signaled, or communicated to an alarm module, according to embodiments herein. In some instances, a fault condition is a software component failure. In some embodiments, a software component is a first DU software component, element, or module. In some embodiments, software switching, updating, or upgrading includes various processes. In some embodiments, a software component failure is an error or failure in one or more processes associated with software switching, updating, or upgrading. For example, a failure occurs when an error during a software upgrade causes a processor to freeze, in some embodiments. In some embodiments, a software component failure occurs when a first DU application fails or is not working. In some instances, a fault condition is a software issue within a first DU which limits functionality of the first DU. In some instances, the software issue includes a software update, freezing of software, crashing of software, a software incompatibility, or another suitable software issue. In some embodiments, the software issue prevents the first DU from communicating with related RUs or an optical switch. In some embodiments, the software issue limits the functionality of the first DU by preventing the first DU from performing at least one assigned function.

In some embodiments, an optical fault is detected by a loss of signal, communication, current, or connection from first DU at alarm module. In some embodiments, an optical fault is detected by a loss of current in a circuit including first DU. In some embodiments, an optical fault is detected by a loss of current from fifth connection at alarm module.

In operation 504, an alarm or fault condition is triggered, delivered, signaled, propagated, or communicated to an optical switch, according to embodiments herein. In some embodiments, an alarm or fault condition is triggered, delivered, signaled, propagated, or communicated to an optical switch using one or more pins.

In operation 506, an alarm or fault condition is triggered, delivered, signaled, propagated, or communicated to a second distributed unit, according to embodiments herein. In some embodiments, an alarm or fault condition is triggered, delivered, signaled, propagated, or communicated to a second distributed unit from an optical switch or an alarm module, according to embodiments herein.

In operation 508, traffic is re-directed or re-routed according to systems or methods described herein. In some embodiments, an optical switch carries out a failover process includes re-routing traffic from a first path to a second path to mitigate the impact of an optical fault.

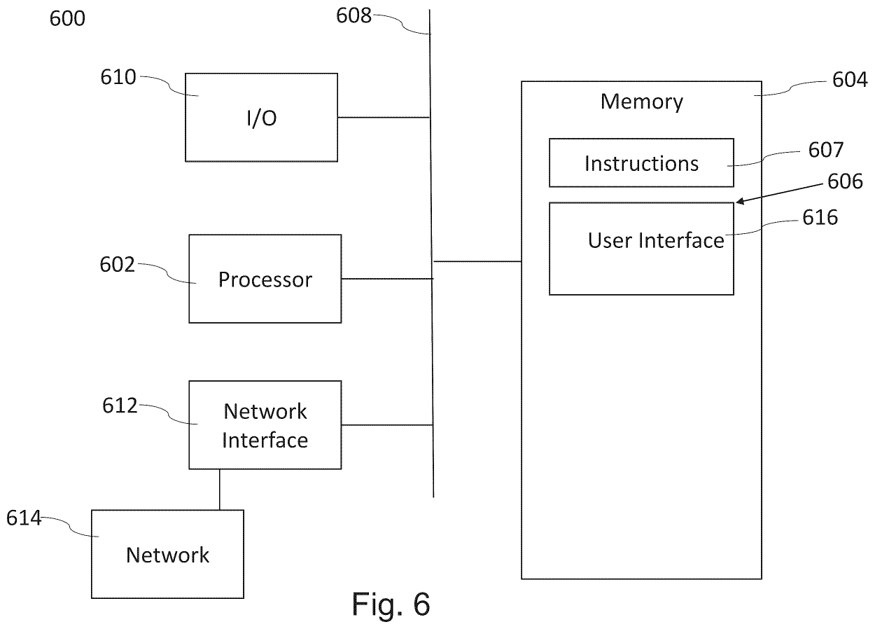

FIG. 6 is a block diagram of computer architecture 600 in accordance with some embodiments.

Computer architecture 600 includes a hardware processor 602 and a non-transitory, computer readable storage medium 604 encoded with, i.e., storing, the computer program code 606, i.e., a set of executable instructions. Computer readable storage medium 604 is also encoded with instructions 607 for interfacing with external devices. The processor 602 is electrically coupled to the computer readable storage medium 604 via a bus 608. The processor 602 is also electrically coupled to an I/O interface 610 by bus 608. A network interface 612 is also electrically connected to the processor 602 via bus 608. Network interface 612 is connected to a network 614, so that processor 602 and computer readable storage medium 604 are capable of connecting to external elements via network 614. The processor 602 is configured to execute the computer program code 606 encoded in the computer readable storage medium 604 in order to cause computer architecture 600 to be usable for performing a portion or all of the operations as described herein.

In some embodiments, the processor 602 is a central processing unit (CPU), a multi-processor, a distributed processing system, an application specific integrated circuit (ASIC), or a suitable processing unit.

In some embodiments, the computer readable storage medium 604 is an electronic, magnetic, optical, electromagnetic, infrared, or a semiconductor system (or apparatus or device). For example, the computer readable storage medium 604 includes a semiconductor or solid-state memory, a magnetic tape, a removable computer diskette, a random access memory (RAM), a read-only memory (ROM), a rigid magnetic disk, or an optical disk. In some embodiments using optical disks, the computer readable storage medium 604 includes a compact disk-read only memory (CD-ROM), a compact disk-read/write (CD-R/W), or a digital video disc (DVD).

In some embodiments, the storage medium 604 stores the computer program code 606 configured to cause computer architecture 600 to perform a portion or all of the operations as described herein. In some embodiments, the storage medium 604 also stores information needed for performing a portion or all of the operations as described herein as well as information generated during performing a portion or all of the operations as described herein, such as a user interface parameter 616.

In some embodiments, the storage medium 604 stores instructions 607 for interfacing with external devices. The instructions 607 enable processor 602 to generate instructions readable by the external devices to effectively implement a portion or all of the operations as described herein.

Computer architecture 600 includes I/O interface 610. I/O interface 610 is coupled to external circuitry. In some embodiments, I/O interface 610 includes a keyboard, keypad, mouse, trackball, trackpad, or cursor direction keys for communicating information and commands to processor 602.

Computer architecture 600 also includes network interface 612 coupled to the processor 602. Network interface 612 allows computer architecture 600 to communicate with network 614, to which one or more other computer systems are connected. Network interface 612 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described herein, and information are exchanged between different computer architecture 600 via network 614.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, or processors supplied with computer-readable instructions stored on computer-readable media. In at least some embodiments, dedicated circuitry includes digital or analog hardware circuits and include integrated circuits (IC) or discrete circuits. In at least some embodiments, programmable circuitry includes reconfigurable hardware circuits including logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network or a wireless network. In at least some embodiments, the network includes copper transmission cables, optical transmission fibers, wireless transmission, routers, firewalls, switches, gateway computers or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiments of the subject disclosure have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by ‘prior to,’ ‘before,’ or the like and as long as the output from a previous process is not used in a later process. Even if the process flow is described using phrases such as ‘first’ or ‘next’ in the claims, embodiments, or diagrams, such a description does not necessarily mean that the processes must be performed in the described order.

### Supplemental Note 1

A system includes an optical switch. The system further includes a first distributed unit (DU) configured to receive first traffic directed from the optical switch along a first optical path, wherein the first DU is configured to generate an alarm condition in response to a failure in a software component of the first DU, and a second DU configured to receive second traffic directed from the optical switch along a second optical path, wherein the optical switch, in response to receiving the alarm condition, is configured to terminate transmission of the first traffic from the optical switch along the first optical path, and transmit the second traffic directed from the optical switch along a second optical path.

### Supplemental Note 2

In some embodiments, the system of Supplemental Note 1 wherein the first DU is configured to cease generating the alarm condition in response to a determination that the failure is resolved.

### Supplemental Note 3

In some embodiments, the system of any of Supplemental Notes 1 and 2 wherein the optical switch, in response to ceasing to receive the alarm condition, is configured to: terminate transmission of the second traffic directed from the optical switch along the second optical path, and transmit third traffic from the optical switch along the first optical path.

### Supplemental Note 4

In some embodiments, the system of any of Supplemental Notes 1-3 further comprising an alarm module configured to receive the alarm condition from the first DU and to transmit the alarm condition to the optical switch.

### Supplemental Note 5

In some embodiments, the system of any of Supplemental Notes 1-4 wherein the optical switch is configured to generate a notification signal in response to receiving the alarm condition from the alarm module.

### Supplemental Note 6

In some embodiments, the system any of Supplemental Notes 1-5 wherein the alarm module is configured to transmit the notification signal to the second DU.

### Supplemental Note 7

In some embodiments, the system any of Supplemental Notes 1-7 further comprising a first set of radio units (RUs) connected to the first DU and a second set of RUs connected to the second DU.

### Supplemental Note 8

A method includes transmitting first traffic from an optical switch along a first optical path to a first distributed unit (DU), wherein the first DU is configured to generate an alarm condition in response to a failure in a software component of the first DU, and in response to receiving the alarm condition at the optical switch, terminating transmission of the first traffic from the optical switch along the first optical path, and transmitting second traffic from the optical switch along a second optical path.

### Supplemental Note 9

The method of Supplemental Note 8, further comprising ceasing receiving the alarm condition at the optical switch in response to a determination that the failure is resolved.

### Supplemental Note 10

The method of Supplemental Note 8 or 9 further comprising: in response to ceasing receiving the alarm condition terminating transmission of the second traffic from the optical switch along the second optical path, and transmitting third traffic from the optical switch along the first optical path.

### Supplemental Note 11

The method of any of Supplemental Notes 8-10 further comprising receiving the alarm condition from the first DU at an alarm module, and transmitting the alarm condition to the optical switch from the alarm module.

### Supplemental Note 12

The method of any of Supplemental Notes 8-11, further comprising generating, by the optical switch, a notification signal in response to receiving the alarm condition from the alarm module.

### Supplemental Note 13

The method of any of Supplemental Notes 8-12, further comprising transmitting, from the alarm module, the notification signal to the second DU.

### Supplemental Note 14

A device includes an optical switch configured to transmit first traffic, along a first optical path, to a first distributed unit (DU), wherein the first DU is configured to generate an alarm condition in response to a failure in a software component of the first DU, and the optical switch further configured to, in response to receiving the alarm condition terminate transmission of the first traffic along the first optical path, and transmit second traffic, along a second optical path, to a second distributed unit (DU).

### Supplemental Note 15

The device of Supplemental Note 14, wherein the device is configured to, in response to ceasing to receive the alarm condition terminate transmission of the second traffic from the optical switch along the second optical path, and transmit third traffic from the optical switch along the first optical path.

### Supplemental Note 16

The device of any of Supplementals Notes 14-15, further comprising an alarm module.

### Supplemental Note 17

The device of any of Supplementals Notes 14-16, wherein the alarm module is configured to receive the alarm condition from the first DU and to transmit the alarm condition to the optical switch.

### Supplemental Note 18

The device of any of Supplementals Notes 14-17, wherein the alarm module is configured to transmit a notification signal to the second DU.

### Supplemental Note 19

The device of any of Supplementals Notes 14-18, wherein the device is configured to communicated with a first set of radio units (RUs) connected to the first DU and a second set of RUs connected to the second DU.

### Supplemental Note 20

The device of any of Supplementals Notes 14-19, wherein the alarm condition is received based on failure to receive an expected optical signal, failure to receive an optical signal comprising readable data, or receiving an incomplete optical signal.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system comprising:
an optical switch;
a first distributed unit (DU) configured to receive first traffic directed from the optical switch along a first optical path, wherein the first DU is configured to generate an alarm condition in response to a failure in a software component of the first DU; and
a second DU configured to receive second traffic directed from the optical switch along a second optical path, wherein
the optical switch, in response to receiving the alarm condition, is configured to:
terminate transmission of the first traffic from the optical switch along the first optical path, and
transmit the second traffic directed from the optical switch along a second optical path.

2. The system of claim 1, wherein the first DU is configured to cease generating the alarm condition in response to a determination that the failure is resolved.

3. The system of claim 2, wherein the optical switch, in response to ceasing to receive the alarm condition, is configured to:
terminate transmission of the second traffic directed from the optical switch along the second optical path, and
transmit third traffic from the optical switch along the first optical path.

4. The system of claim 1, further comprising an alarm module configured to receive the alarm condition from the first DU and to transmit the alarm condition to the optical switch.

5. The system of claim 4, wherein the optical switch is configured to generate a notification signal in response to receiving the alarm condition from the alarm module.

6. The system of claim 5, wherein the alarm module is configured to transmit the notification signal to the second DU.

7. The system of claim 1, further comprising:
a first set of radio units (RUs) connected to the first DU; and
a second set of RUs connected to the second DU.

8. A method comprising:
transmitting first traffic from an optical switch along a first optical path to a first distributed unit (DU), wherein the first DU is configured to generate an alarm condition in response to a failure in a software component of the first DU; and
in response to receiving the alarm condition at the optical switch:
terminating transmission of the first traffic from the optical switch along the first optical path, and
transmitting second traffic from the optical switch along a second optical path.

9. The method of claim 8, further comprising:
ceasing receiving the alarm condition at the optical switch in response to a determination that the failure is resolved.

10. The method of claim 9, further comprising:
in response to ceasing receiving the alarm condition:
terminating transmission of the second traffic from the optical switch along the second optical path, and
transmitting third traffic from the optical switch along the first optical path.

11. The method of clam 8, further comprising:
receiving the alarm condition from the first DU at an alarm module; and
transmitting the alarm condition to the optical switch from the alarm module.

12. The method of claim 11, further comprising:
generating, by the optical switch, a notification signal in response to receiving the alarm condition from the alarm module.

13. The method of claim 12, further comprising:
transmitting, from the alarm module, the notification signal to the second DU.

14. A device comprising:
an optical switch configured to transmit first traffic, along a first optical path, to a first distributed unit (DU), wherein the first DU is configured to generate an alarm condition in response to a failure in a software component of the first DU; and
the optical switch further configured to, in response to receiving the alarm condition:
terminate transmission of the first traffic along the first optical path, and
transmit second traffic, along a second optical path, to a second distributed unit (DU).

15. The device of claim 14, wherein the device is configured to, in response to ceasing to receive the alarm condition:
terminate transmission of the second traffic from the optical switch along the second optical path, and
transmit third traffic from the optical switch along the first optical path.

16. The device of claim 15, further comprising:
an alarm module.

17. The device of claim 14, wherein the alarm module is configured to receive the alarm condition from the first DU and to transmit the alarm condition to the optical switch.

18. The device of claim 17, wherein the alarm module is configured to transmit a notification signal to the second DU.

19. The device of claim 14, wherein the device is configured to communicated with a first set of radio units (RUs) connected to the first DU and a second set of RUs connected to the second DU.

20. The device of claim 14, wherein the alarm condition is received based on failure to receive an expected optical signal, failure to receive an optical signal comprising readable data, or receiving an incomplete optical signal.
